(19) United States
(12) Patent Application Publication
(10) Pub. No.: US 2010/0042988 A1
(43) Pub. Date: Feb. 18, 2010

(54) Installation Management using Virtual Machines

(75) Inventors: Christer Lundin, Redmond, WA (US); Dmitry Sonkin, Redmond, WA (US); Israel Hilerio, Kenmore, WA (US); Robert M. Fries, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/191,372

(22) Filed: Aug. 14, 2008

(51) Int. Cl. G06F 9/445

(52) U.S. Cl. 717/176

(57) ABSTRACT

Computer components may be installed and configured using virtual machines, where a trusted relationship with a virtual machine is created when a virtual machine is launched on a device with an installation manager. The installation manager may provide configuration options, scripts, and other information to a configuration agent operating in the virtual machine. Additional virtual machines may be launched on other devices and trusted relationships established with the installation manager, which may also manage configuration agents on the additional virtual machines. In some embodiments, a remote controller may be used to control functions of the installation manager.

### BACKGROUND

Integrated computer components can be challenging to install and configure, especially when there are interdependencies between different components. In a complex server system, multiple computer components may operate across one or more devices to provide various services to client devices.

### SUMMARY

Computer components may be installed and configured using virtual machines, where a trusted relationship with a virtual machine is created when a virtual machine is launched on a device with an installation manager. The installation manager may provide configuration options, scripts, and other information to a configuration agent operating in the virtual machine. Additional virtual machines may be launched on other devices and trusted relationships established with the installation manager, which may also manage configuration agents on the additional virtual machines. In some embodiments, a remote controller may be used to control functions of the installation manager.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system with a virtual machine installation mechanism.

FIG. 2 is a flowchart illustration of an embodiment showing a method for installation using secure communications.

### DETAILED DESCRIPTION

An installation and configuration system may use configuration agents within a virtual machine to perform some tasks. One or more virtual machines may be launched on a device on which a management controller application is operating, and trusted relationships may be established between the management controller and a configuration agent. Additional virtual machines may be launched on the same or other devices and trusted relationships established between the various installation components.

The trusted relationships may be used amongst the various components to transfer credentials and configure the components so that the components may interact using various trusted mechanisms. For example, trusted relationships between the installation components may be used to transfer private encryption keywords or other credentials that may be used by the various components after installation to authenticate between the components.

The installation and configuration system may be used to install any type of computer component, and one example is the installation and configuration of server systems that have many different components that may interact.

For example, a server system may have various components for email and other message management, storage management including directory services and user authentication, and another component for security related services such as gateway functions, communications logging, and anti-malware scanning. In such an example, each component may operate on one or more devices yet may interact with one or more other components. When fully configured and operating, the gateway function may operate on one device and may communicate with the user authentication function that operates on another device. The communication may use an authentication mechanism so that the communication is secure.

In the example, the installation of the various components may include establishing credentials on two devices or components so that the components may communicate in a secure manner. The trusted relationships established during the installation and configuration process may be used to transmit the credentials between the components.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

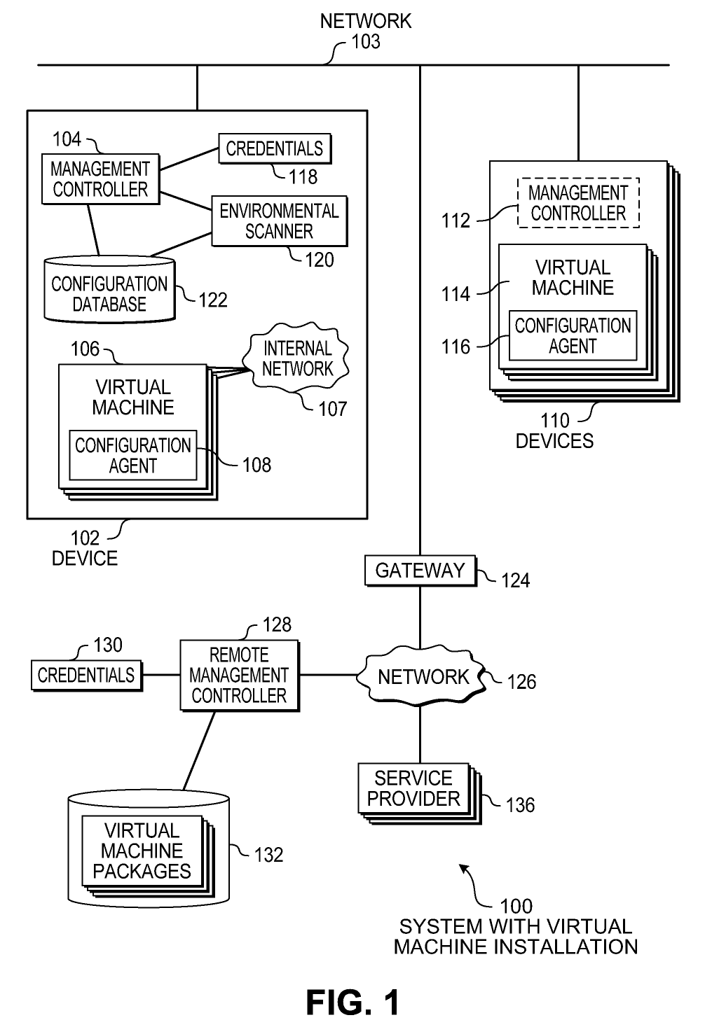

FIG. 1 is a diagram of an embodiment 100 showing an installation system that may use virtual machines. Embodiment 100 is a simplified example of an installation system that may be used to install and configure various components on a local system, systems connected through a local area network, and systems available through a wide area network. The various components may be installed using virtual machines and configuration agents on the virtual machines.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 100 is an example of an installation system that may install components on a local device, other devices on a local area network, as well as remotely provided services. The installation system may use virtual machines to perform configuration tasks and, in some cases, the virtual machines may be used to operate the components.

A virtual machine may be a software construct that executes programs like a hardware device. In many cases, a virtual machine may operate an operating system on which various applications may execute.

During an installation and configuration process, a secure communication channel between various components may be useful. For example, code words, configuration keys, private encryption keys, and other sensitive information may be transferred between components during configuration. The sensitive information may include data or other information for which authenticated communications may be created after the components are operating.

One mechanism for installing and configuring a component may include executing a virtual machine. The virtual machine may execute a preconfigured installation component or configuration agent that may install and configure the component. In some cases, the component may be configured to operate within the virtual machine. In other cases, the component may be configured to operate natively on the same hardware device as the virtual machine or on a different hardware device as the virtual machine.

A component that may be installed and configured may be any application, service, hardware device, software element, or other component that may operate within a computing environment. In many cases, the component may interact with other components and may do so using authenticated or secure communications.

In an example of a use for an installation and configuration system, a group of components may be installed and configured on a group of server computers. In the example, one of the group of servers may be configured with a user authentication system that manages user accounts and provides verification of user credentials. A second server may be configured with a messaging system that may manage email and other messaging services. When operating, the messaging system may use a secure communications channel to verify user credentials when a user accesses a mailbox on the messaging system, for example.

During installation of the example servers, a single management controller may manage the installation and configuration process. The management controller may launch a virtual machine on a local system that may configure the user authentication system and may launch a virtual machine on another server to install and configure the messaging system. When the virtual machines are launched, the management controller may establish secure communication channels with the virtual machines. The secure communication channel may be used for transmitting installation keys, encryption keys, or other information which may be included in various configuration parameters that may customize or adapt a component to a specific environment.

In some embodiments, a virtual machine may be used to install and configure a component to operate in a native mode. In such a case, the virtual machine may execute a configuration agent that may install and configure a component on another virtual machine or a hardware machine. In other embodiments, a virtual machine may be used to install and configure a component to operate within the same virtual machine.

In still other embodiments, a virtual machine may be launched on a local hardware device and configured, but the virtual machine may be moved to another hardware platform for normal operation.

When a virtual machine is launched and operated on a local hardware platform, an inherently secure communications channel may be created since a management controller may be able to communicate to the virtual machine through channels that are limited to the local hardware platform. In many cases, such channels may be created so that no communications are permitted outside the hardware platform. Some embodiments may create a local internal network through which virtual machines operating on a hardware platform may communicate with applications operating natively on the hardware platform.

For the purposes of this specification and claims, native operation of a component may refer to the operation of the component in a non-virtual manner on a hardware platform. In some cases, the native operation may involve executing a software component within a host operating system environment.

Embodiment 100 illustrates a device 102 that may be connected to a network 103. The device 102 may be any type of computing device, such as a server, workstation, desktop or laptop personal computer, handheld personal digital assistant, wireless telephone device, or any other computing device. The network 103 may be a local area network or other type of network, and the device 102 may connect to the network 103 through wired or wireless connections.

The device 102 may have a management controller 104 that may manage and direct the installation and configuration of various components.

The terms installation and configuration may be used to refer to any operation that enables a component to function within an environment. The terms are used interchangeably in this specification and may include operations such as unpacking and copying files into directory structures, establishing and adjusting configuration files or other settings that may change the behavior of a component, defining and testing communication paths with other components, and any other operation which may be performed prior to operation of a component.

In many embodiments, multiple components may be installed and configured together. In some cases, each component may have some installation operations performed and, after each component is operable with at least some functionality, the components may be further configured to operate with each other.

The management controller 104 may organize the installation and configuration of one or more components. When a component is installed, the management controller may launch a virtual machine 106 which may contain a configuration agent 108. The configuration agent 108 may be an executable program that may perform much of the installation and configuration operations or activities for the specific component, and may receive various configuration parameters from the management controller 104.

In many cases, one or more locally launched virtual machines 106 may communicate with the management controller 104 using an internal network 107. The internal network 107 may operate by sending messages within the device 102 and, in some embodiments, may not have a connection to external networks such as network 103. Because the internal network 107 is local to the device 102, communications between the management controller 104 and the virtual machines 106 may be considered to be secure, even if various secure protocols, authentication, or other secure mechanisms are not used in the communications.

The secure communications between the management controller 104 and the configuration agents 108 may include various configuration parameters, including communications that would generally use secure channels, such as encryption keys, authorization credentials, access keys for a component, or other parameters. In many instances, the secure communications between the management controller 104 may be used to exchange credentials so that authenticated communications may be established later. Such credential exchange may be performed using unsecured or unencrypted communications across an internal network 107. During subsequent operations, the credentials exchanged during the communications on the internal network 107 may enable communication across the external network 103 in a secure manner.

The management controller 104 may be capable of launching multiple local virtual machines 106. In some instances, a single virtual machine may install and configure a single component. In other instances, a single virtual machine may install and configure multiple components, or a single component may be installed and configured with multiple virtual machines.

The management controller 104 may also be capable of launching and managing virtual machines 114 on other devices 110. In some cases, a management controller 112 may be operable on the other devices 110.

The management controller 112 operable on another device 110 may operate as a slave to the management controller 104. In such a use, the management controller 104 may issue commands or queries to the management controller 112, and the management controller 112 may respond as requested. In such a case, the management controller 104 may control the overall sequence of installation and configuration and may provide configuration parameters to the management controller 112 for forwarding to configuration agents 116 operable on the device 110.

When two management controllers 104 and 112 are used during an installation and configuration sequence, a secure communication path may be established between the management controllers 104 and 112. Each management controller may be capable of communicating to locally running configuration agents on the respective local devices in a secure manner, such as with the internal network 107.

A secure communication path between the management controllers 104 and 112 may be established using various mechanisms. In some cases, a manual mechanism may involve having a user install the management controllers 104 and 112 on each device prior to automatically or manually establishing secure communications between the two devices. In other cases, the management controller 104 may cause the management controller 112 to be installed and configured on the device 110 without a user interaction.

The management controller 104 may have an environmental scanner 120 that may scan the device 102 and any devices attached to the network 103 to determine various configuration parameters. The environmental scanner 120 may walk the network 103 by various searching mechanisms to collect status information, hardware configuration information, software configuration information, network characteristics, presence of other devices, and other information that may be useful when installing and configuring components. The environmental scanner 120 may store the collected information in a configuration database 122.

The configuration database 122 may store configuration information that may be used during installation and configuration, and data that may be common to and shared amongst other components during installation. In many embodiments, the results of a configuration of a component may be stored in the configuration database 122 so that components that are configured later may use the results to interact with the previously installed component.

The management controller 104 may have various credentials 118 that may be used to authenticate the management controller 104 to another device and have the other device authenticate to the management controller 104. In some instances, a one-way authentication may be used while in other instances, two-way authentication may be used. One example of credentials 118 may include private key-public key encryption keys.

The management controller 104 may be capable of communicating through a gateway 124 and a network 126 to a remote management controller 128. The remote management controller 128 may have credentials 130, a credential server 134, and other mechanisms by which secure communications may be performed.

The network 126 may include the Internet, and the remote management controller 128 may be a remotely hosted service through which at least a portion of the installation and configuration process may be performed. In some embodiments, the remote management controller 128 may have a database 132 that may contain copies of virtual machine packages that may be downloaded and launched by a management controller 104 or one of the configuration agents.

In many embodiments, a virtual machine package may include a virtual machine that is preconfigured to operate. The virtual machine package may include executable files, data files, registry settings, and other configuration items. Many virtual machine packages may be preconfigured to be loaded and executed to perform specific functions, such as to configure and operate a service within the virtual machine environment.

In some embodiments, the remote management controller 128 may use its credentials 130 to establish a trusted and secure communication path with the management controller 104.

In some embodiments, the remote management controller 128 may perform many of the tasks previously described for the management controller 104, including scheduling installation and configuration operations, launching virtual machines, and communicating with the configuration agents operating on the virtual machines.

In many embodiments, a virtual machine 106 may install and configure a remote service from a service provider 136. A service provider 136 may provide one or more services that may otherwise be provided by a locally running process. Examples of such services include email services, customer resource management services, database applications, and other applications and services.

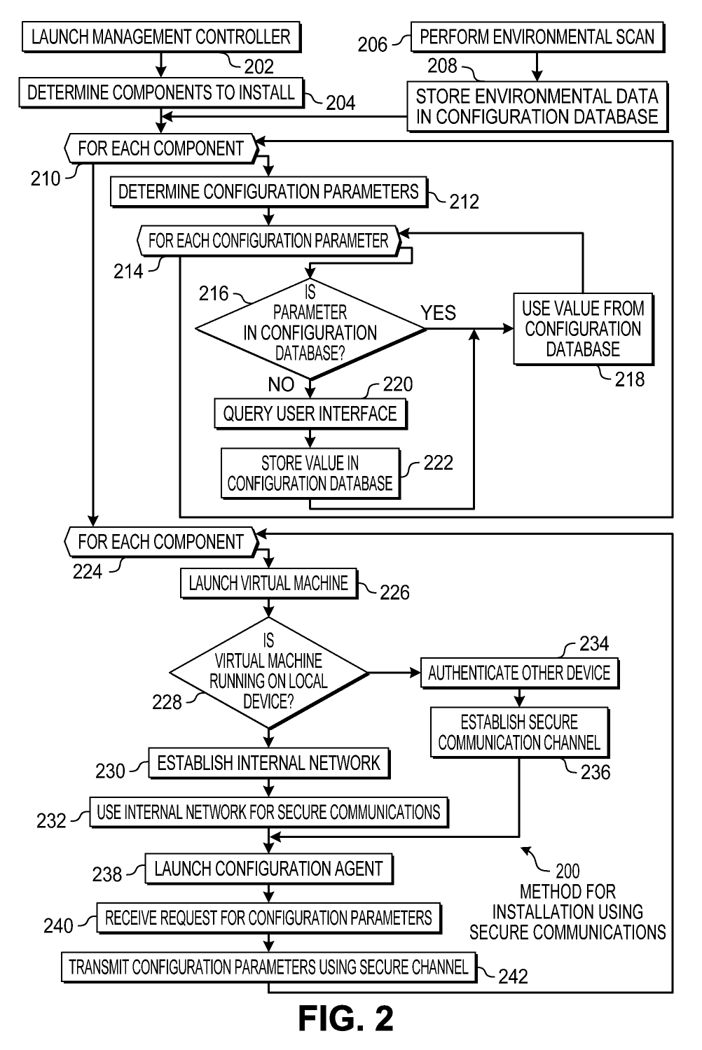

FIG. 2 is a flowchart illustration of an embodiment 200 showing a method for installation and configuration using secure communications. Embodiment 200 is a simplified example of gathering configuration data, launching virtual machines that have configuration agents, and communicating with the configuration agents using secure communications. Once the configuration agents have configuration data, the configuration agents may perform installation and configuration tasks.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 is a simplified example of the operations that may be performed by a management controller, such as the management controller 104.

The management controller may be launched in block 202. In many cases, the management controller may be launched in native mode on a device on which a service or application is to be installed. In other embodiments, the management controller may be a remote management controller accessed outside of a local area network, or may be operating on one device and may cause a component to be installed and configured on another device within a local area network.

The components to be installed may be selected in block 204. In some cases, the components to be installed may be selected from a user interface, for example, or from some other mechanism. In many cases, an application, service, or suite of applications or services may be installed using a script or some other definition.

In some embodiments, an environmental scan may be performed in block 206. The environmental scan may include passive monitoring and active detection of any type of hardware or software configuration for a local device, devices connected to a local network, or other devices outside a local network. Data collected from the environmental scan may be stored in a configuration database in block 208.

In some embodiments, the environmental scan of block 206 may be performed prior to selecting the components to install in block 204. In one such embodiment, the environmental scan may be part of a monitoring system that performs various logging and monitoring operations for a single device or a group of devices.

In other embodiments, the environmental scan of block 206 may be performed after selecting components to install in block 204. In such an embodiment, the environmental scan of block 206 may be directed toward collecting some predefined parameters.

For each of the components selected in block 210, the components may be prepared in block 210. The configuration parameters for the component may be determined in block 212. For each of the parameters in block 214, if the parameter is in the configuration database in block 216, the value from the configuration database may be used in block 218. If the parameter is not in the configuration database in block 216, a query may be made to a user interface in block 220 and the value may be stored in the configuration database in block 222. The value from the configuration database may then be used in block 218 for the parameter.

After preparing the configuration data for each component in block 210, each component may be installed and configured in block 224.

For each component in block 224, a virtual machine may be launched in block 226. If the virtual machine is running on the local device in block 228, an internal network connection may be established in block 230 and the internal network may be used for secure communications in block 232.

The internal network of block 230 may or may not use secure communication techniques such as authentication, encryption, or other mechanisms. Because the network is internal to a single device, the parties using the network may be limited to the host device and the virtual machines operating on the device. Since the network is internal, sensitive information may be transmitted across the internal network without a security issue.

If the virtual machine is not running on a local device in block 228, the other device may be authenticated in block 234 and a secure channel may be established in block 236. The secure channel of block 236 may use any type of security mechanism, including encryption, authentication, or other security mechanisms to establish a secure communication channel.

A configuration agent may be launched in block 238. The configuration agent of block 238 may be an application, script, or other executable that may begin the installation and configuration process. The configuration agent may operate within the virtual machine launched in block 226.

A request may be received from the configuration agent for configuration parameters in block 240. The request may define the configuration parameters that may be used by the configuration agent. The configuration parameters may be transmitted using a secure channel in block 242.

In some embodiments, a management controller may process multiple requests from a single configuration agent. Embodiment 200 illustrates a single request and response, but other embodiments may have many such exchanges as in blocks 240 and 242.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
starting a management controller application on a first device;
launching a first virtual machine on said first device, said first virtual machine having a first configuration agent;
establishing a first trusted relationship between said management controller application and said first configuration agent;
determining a set of configuration parameters form a configuration database;
transferring said set of configuration parameters to said first configuration agent using said first trusted relationship; and
causing said first configuration agent to perform a configuration activity using said set of configuration parameters.

2. The method of claim 1, said trusted relationship being implied by said first virtual machine being operated on said first device.

3. The method of claim 1, said trusted relationship being established by an authentication method.

4. The method of claim 1 further comprising:
establishing a trusted relationship with a remote management controller.

5. The method of claim 4, said remote management controller being located within a local area network.

6. The method of claim 4, said remote management controller being located across a wide area network connection.

7. The method of claim 4, said management controller application being configured to perform a method comprising:
receiving a message from said remote management controller; and
transmit said message to said configuration agent.

8. The method of claim 1, at least one of said set of configuration parameters being determined by performing an environmental scan.

9. The method of claim 8, said environmental scan being performed on a plurality of devices connected to a network.

10. A system comprising:
a first virtual machine package comprising a first executable package and a first configuration agent, said first virtual machine package being operable on a first device;
a configuration database; and
a first management controller operable on said first device and configured to establish a trusted relationship with said first configuration agent, determine a first set of configuration parameters, at least one of said configuration parameters being stored in said configuration database, and transmit said first set of configuration parameters to said first configuration agent, said first management controller being further configured to cause a configuration activity using said set of configuration parameters.

11. The system of claim 10 further comprising:
an environmental scanner configured to collect at least one of said configuration parameters and store said at least one of said configuration parameters in said configuration database.

12. The system of claim 11, said environmental scanner being configured to scan a plurality of devices connected to a network.

13. The system of claim 10 further comprising:
a second virtual machine package comprising a second configuration agent configured to receive a second set of configuration parameters.

14. The system of claim 13, said second virtual machine package being operable on said first device.

15. The system of claim 13, said second virtual machine package being operable on a second device.

16. The system of claim 15 further comprising:
a second management controller operable on said second device and configured to communicate with said first management controller using a trusted communication path.

17. The system of claim 10 further comprising:
a remote management controller configured to communicate with said first management controller across a wide area network using a trusted communication path.

18. A computer readable storage medium comprising computer executable instructions configured to perform a method comprising:
operating a first management controller on a first device;
launching a first virtual machine on said first device, said first virtual machine comprising a first configuration agent, said first configuration agent being configured to receive a first set of configuration parameters and perform a first configuration operation using said first set of configuration parameters;
establishing a first trusted relationship between said first management controller and said first configuration agent;
determining a set of configuration parameters and transmitting said set of configuration parameters to said first virtual machine using said trusted relationship by said first management controller;
communicating with a second management controller on a second device;
establishing a second trusted relationship between said first management controller and said second management controller; and
launching a second virtual machine on said second device, said second virtual machine comprising a second configuration agent, said second configuration agent being configured to receive a second set of configuration parameters and perform a second configuration operation using said second set of configuration parameters.

19. The computer readable storage medium of claim 18, said method further comprising:
establishing a third trusted relationship between a remote management controller and said first management controller; and
receiving at least one of said configuration parameters from said remote management controller.

20. The computer readable storage medium of claim 18, said method further comprising:
performing an environmental scan of a network comprising at least said first device and said second device;
determine at least one of said configuration parameters from said environmental scan; and
populate at least a portion of a configuration database with said at least one of said configuration parameters.
